(19) United States
(12) Patent Application Publication
(10) Pub. No.: US 2003/0204539 A1
(43) Pub. Date: Oct. 30, 2003

(54) Facility protection utilizing fault tolerant storage controllers

(76) Inventor: James R. Bergsten, Danville, CA (US)

Correspondence Address: LSI LOGIC CORPORATION, 1621 BARBER LANE, MS: D-106 LEGAL, MILPITAS, CA, 95035, US

(21) Appl. No.: 10/135,246

(22) Filed: Apr. 30, 2002

(51) Int. Cl. G06F 12/00

(52) U.S. Cl. 707/204

(57) ABSTRACT

The present invention is directed to a system and method for providing redundant geographically disparate data storage. The present invention allows for the geographic separation of data storage nodes to minimize the risks posed by terrorism, theft and natural disasters. A system of the present invention includes a plurality of nodes capable of storing data including redundant data from other nodes within the system. Communication links permit the transfer of data from node to node and between a computer interfacing with stored data. An alternate communication path is included to allow consistent communication in the event of communication link failure. The system may utilize multiple communication protocols and latent messaging to insure full redundancy in the event of disaster. The system may further provide transparent data storage for providing efficient access to data.

### FIELD OF THE INVENTION

The present invention generally relates to the field of data storage and particularly to a system and method for providing geographically disparate data storage.

### BACKGROUND OF THE INVENTION

Data handling is increasingly pervasive as society becomes information driven. Tremendous amounts of time and effort are spent on collecting and subsequently handling the data. One area of importance is data storage. Data storage is important because storage failures may cause delay or obliterate data entirely. Often data may be regenerated, although in some instances the information is irretrievably lost. As data handling increases, data storage systems must provide reliable storage and ease of retrieval.

Mass storage systems are susceptible to loss as the number of users and the amount of data increases. Downtime or loss due to faulty data storage or disaster may be catastrophic. In particular, banking networks, corporations, manufactures, and the like often rely on mass data storage. Failure of data storage systems may cause drops in productivity and increased expense. Mass storage systems are vulnerable to disasters, which increase the cost to the organization.

While data storage devices typically are internally redundant, a catastrophic disaster may result in data loss. Terrorism, vandalism, theft, natural disasters and the like may damage the storage devices and cause data loss. Inherently, a lone storage device is susceptible to catastrophic failure, and are vulnerable to disaster.

Therefore, it would be desirable to provide a system and method for providing redundant geographically separate data storage. The data storage system of the present invention allows redundant data back-up while providing ease of access to data and mirroring redundancy.

### SUMMARY OF THE INVENTION

Accordingly, the present invention is directed to a system and method for providing geographically disparate data storage. The present invention is capable of providing transparent data redundancy while retaining ease of access. The invention protects data by providing data storage at various locations thus minimizing risks posed by natural disasters, terrorism, theft, vandalism and the like.

A system for redundant geographically disparate data storage includes a plurality of geographically disparate nodes which are capable of providing redundant data back-up. At least two communication links connect a node of the plurality of nodes to at least two nodes suitable for providing redundancy, such as when changes are made to a data set contained on a node, from a host device included in the system. The at least two communication links further are suitable for providing an alternate path in the event of physical communication link failure. The at least one host device is communicatively coupled to the node. In a further aspects of the present invention an individual host of the at least one host is capable of accessing each node of the plurality of nodes.

A method for providing geographically disparate redundant data storage is discussed. In the present method data, such as changes received from a host, is stored on a node. Data is communicated over a communication link to a primary redundant node for storage. In the event of a communication failure data may be transferred over an alternate path to the primary redundant node. In the event that the primary redundant node fails, for example if a disaster has destroyed the node the data may then be stored on a secondary redundant storage node. Additionally, data also may be stored on a plurality of other nodes within a data storage system implementing the method of the present invention, thus providing n-way recovery for data.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an exemplary embodiment wherein a system for redundant geographically disparate data storage is shown;

FIG. 2 is an illustration of an exemplary embodiment wherein a system for redundant geographically disparate data storage including a host capable of communicating with a plurality of nodes via communication links is shown;

FIG. 3 is an illustration of an exemplary embodiment wherein an individual node is shown;

FIG. 4 is an illustration of an exemplary embodiment wherein a node controller is shown;

FIG. 5 a flow diagram of a method of the present invention wherein geographically disparate data storage is provided;

FIG. 6 is an illustration of an exemplary embodiment wherein a system for redundant geographically disparate data storage including redundant geographically disparate storage controllers is shown; and

FIG. 7 is an illustration of an exemplary embodiment wherein a system for redundant geographically disparate data storage includes redundant geographically disparate storage controllers suitable for accessing at least one storage device is shown.

### DETAILED DESCRIPTION OF THE INVENTION

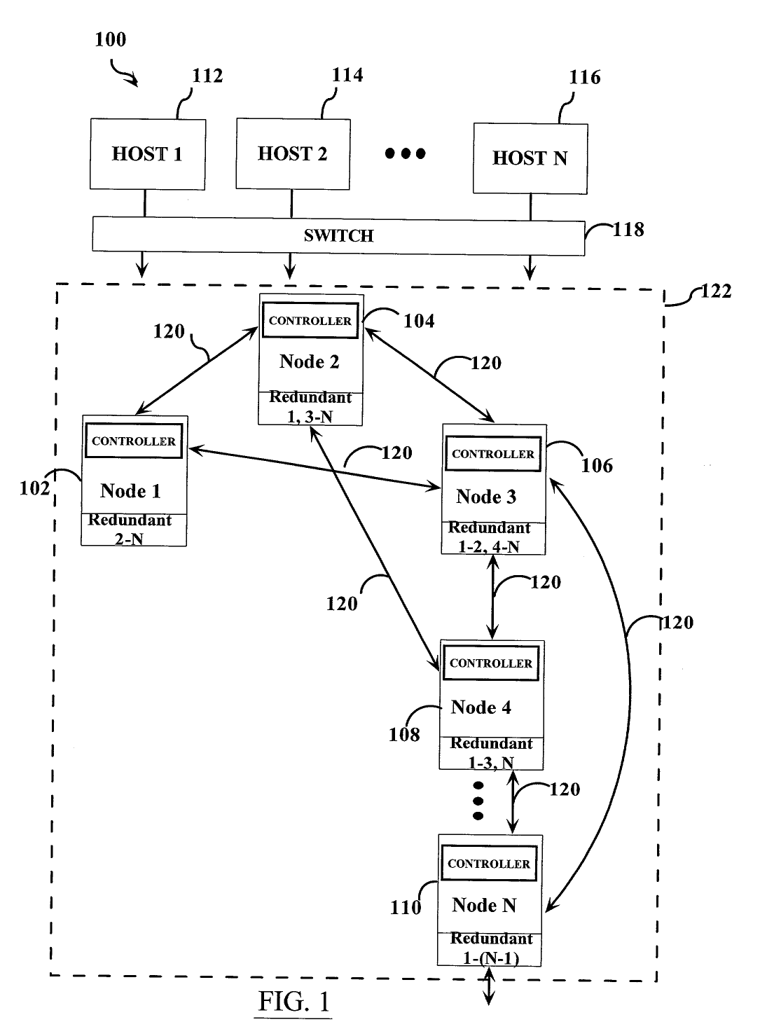

Reference will now be made in detail to the presently preferred embodiments of the invention, examples of which are illustrated in the accompanying drawings. Referring generally to FIGS. 1 through 7, exemplary embodiments of the present invention are shown wherein a system and method for geographically disparate data storage is discussed. The system and method of the present invention allows for the geographic separation of various storage nodes while providing ease of access, transparency and redundancy.

Referring to FIG. 1 an exemplary embodiment of the present invention is shown. A system for redundant geographically disparate data storage 100 includes a plurality of nodes 102, 104, 106, 108 and 110. Nodes 102, 104, 106, 108 and 110 are capable of storing data and providing redundant protection for any other node within the data storage system 100. Nodes 1 though N, 102, 104, 106, 108 and 110 respectively may be disposed at various geographic locations so as to minimize data loss in the event of a disaster and facilitate data storage.

A business implementing the present invention may disperse nodes at various geographic locations, in different facilities, remote locations and the like to coincide with operations and to minimize risk in the event of a disaster. If nodes are geographically dispersed in the event of a natural disaster, terrorism, theft, vandalism and the like the redundant nodes at different locations, such as in different buildings, cities, geographic regions, are suitable for utilization in recovering the effected node. Thus, a fire at a facility housing node one 102 would not effect the redundant nodes for node one (1), such as if node two (2) 104, node three (3), 106 are located remote to node one 102. In the present embodiment node one 102 may be backed-up by geographically disparate nodes of the plurality of nodes.

In the event of damage to a particular node, the unaffected nodes of the plurality of nodes may provide n-way redundancy. Thus if nodes 2 through N 104, 106, 108, 110 are established as redundant nodes for node one 102 then node one may be recovered from any of the redundant nodes 2 through N 104, 106, 108 and 110.

Communicatively coupling at least one node to at least two nodes within the data storage system 100 are at least two communication links 120. Communication links 120 may include a redundant physical link to allow communication should the primary communication link fail. For example, communication link 120 connecting nodes two and three 104 and 106 consists of two separate physical connections to prevent communication disruption.

Communication links may utilize multiple communication protocols to transfer data. Communication protocols include Gigabit Ethernet, Fibre Channel, Asynchronous Transfer Mode (ATM), T1 link and the like. Utilization of multiple communication protocols permits protocol specific recovery. For example, a data storage system of the present invention including Fibre Channel and Gigabit Ethernet based communication links may insure constant connection due to the utilization of multiple protocols.

Suitable physical links include local area networks (LAN), wide area networks (WAN), Ethernet connections, T1 lines and the like. In further aspects of the present invention, communication links with multiple physical connections may permit data transfer over both physical links of the communication link 120. For example, if two physical links are included communication may occur over both thus increasing overall bandwidth.

The data storage system 100 of the present invention includes an alternate communication path. An alternate communication path enables a node to establish a alternate communication link with a redundant node in the event of communication link 120 failure. For example, should the communication link between nodes two 104 and three 106 fail then communication between nodes 2 and 3 may proceed via alternate paths such as via node 3 to node 1 to node 2 or node 3 to node 4 to node 2, thus communication may proceed without interruption. Further, in implementations of the present invention alternate communication paths may additionally be utilized to assist data transfers thus allowing greater bandwidth access and increasing the overall data transfer rate. While the present example is described with particularity, it should be apparent that other implementations are contemplated without departing from the spirit and scope of the present invention, and it is the intention of the present invention to include and encompass such changes.

Communication between the various components of the data storage system 100 may be enhanced through implementation of latent messaging or “keep alive” heartbeat messages. Utilization of latent messaging allows for the detection of possible communication errors, node errors and the like. Latent messaging includes communicating low level messages over communication links 120 to determine if the link between two nodes has failed or if a node has failed. For example, the inability of node three 106 to communicate with node two 104, such as if node two 104 is redundant for node three 106 may be attributed potentially to either communication link failure or to node failure. In the present situation latent messaging may indicate that a physical link has failed, such as the link between nodes two and three 104, 106 or that node two 104 itself is not responding.

At least one host is included in the data storage system 100. In FIG. 1 hosts 1 through N 112, 114 and 116 are discussed. Hosts include information handling systems and the like capable of interfacing with data. For example, host one 114 may be a server computer system suitable for accessing stored data. In the present embodiment a host is capable of interfacing with the plurality of nodes 1 through N 102, 104, 106, 108 and 110. The data storage system of the present invention is capable of transparent data storage. In implementations individual hosts of the at least one host may not substantially discern the actual data storage mode among disparate nodes through the implementation of virtual addressing and the like. For example, nodes 1 through N 102, 104, 106, 108 and 110 may virtually appear to as one node 122. Thus the node may virtually appear to be controlled by a single storage controller. The present invention therefore is capable of providing geographically disparate data storage and its attendant advantages, while providing transparent redundancy.

In a further aspect of the present invention, communication may utilize control information. Control information communicated between components of the data storage system 100 allows the determination of the sending node status. Additionally, control information may cause the transmitting node to direct the receiving node. For example, node three 106 communicates to permit node two 104 to update with a set of changes. Included with or sent prior to the update data is control information directing node two 104 to perform a specific task such as offload data or destage data to an associated cache. In this manner the nodes 102, 104, 106, 108 and 110 of the data storage system 100 may infer and update the state of the data sets from the various nodes.

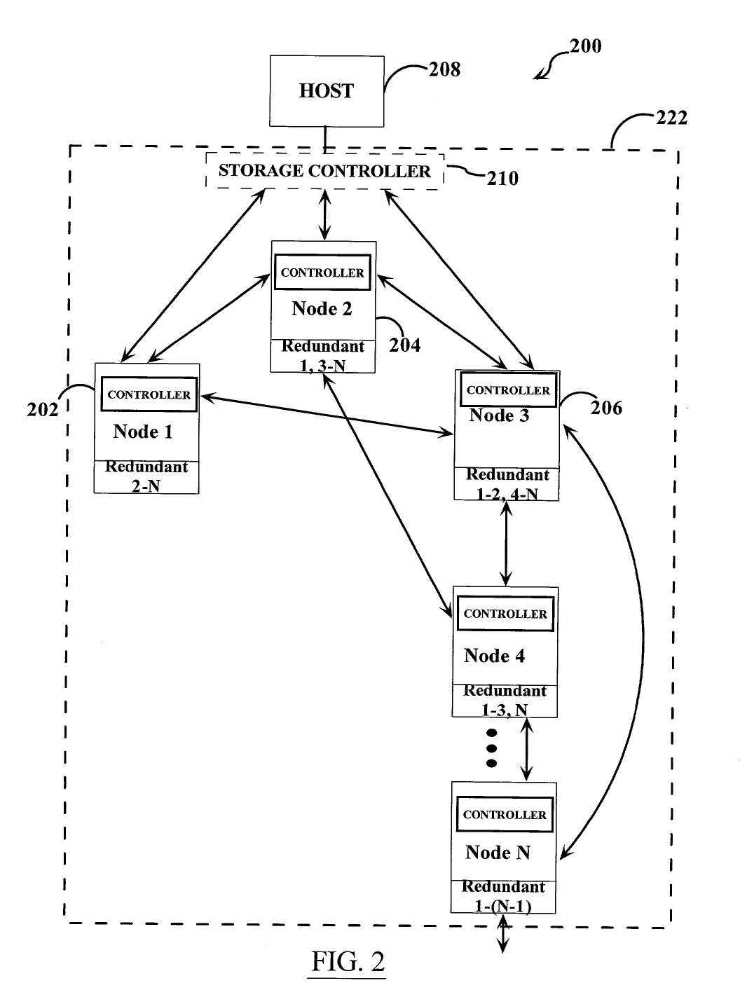

Referring to FIG. 2, a storage system for redundant geographically disparate data storage 200 includes a host 208 which communicates data via an apparent storage controller 210 to at least one node of the plurality of nodes, thus the plurality of nodes appears as a single node controlled by virtual storage controller 210. The host 208 is substantially similar to the host devices as described with regard to FIG. 1. In the present aspect, the data is exchanged with nodes one, two and three 202, 204, and 206 thus, updates to the mirrored data sets stored on nodes one, two and three may be updated from the host thus reducing the communication between nodes. The host 208 may access stored data in substantially the same manner if it is determined that the data sets within the nodes one two and three are mirrored, further increasing overall data transfer.

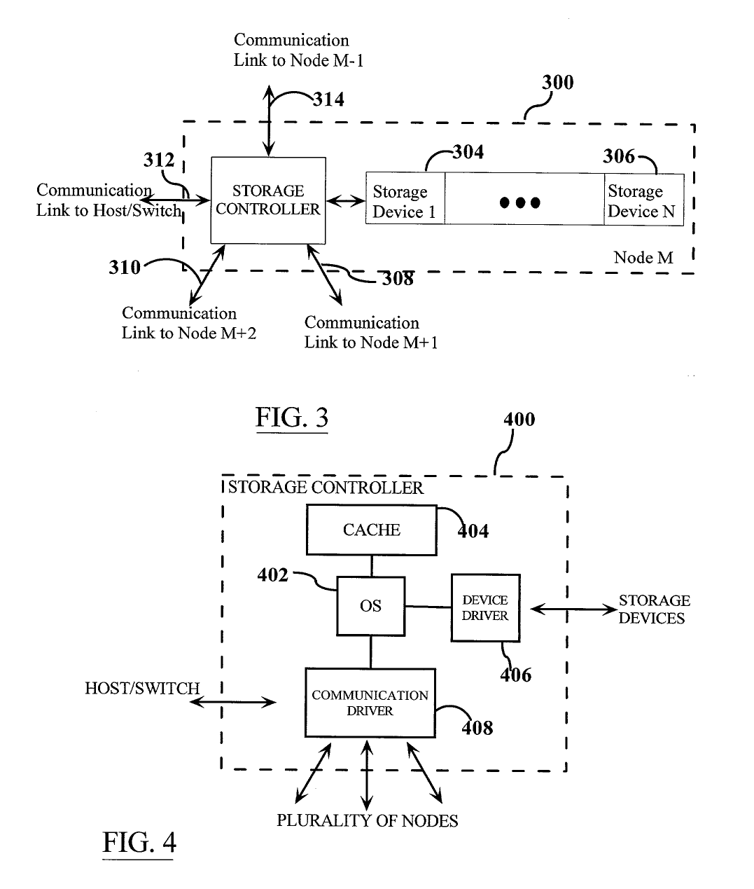

In FIG. 3, an individual node 300 of the present invention is discussed. In the present embodiment, the node includes a storage controller 302 suitable for controlling an array of storage devices, in the present example storage devices one 304 through N 306 are shown. Suitable storage devices include hard drives, tape drives, optical storage devices, magnetic-optical devices, and the like. Optical storage devices may include CD-ROM, CD-R, DVD. Various combinations/arrangements of devices may be desirable and it is within the spirit and scope of the present invention to include these combinations and arrangements. Communication links 308, 310, 312, and 314 connect the node 300 to other nodes within a system for geographically disparate data storage and to hosts/switches associated with host devices.

Referring now to FIG. 4, a storage controller 400 of the present invention is discussed. The storage controller 400 is capable of controlling input/output of data to the storage devices, communication with additional nodes as well as communications with the host/switch. The storage controller 400 includes an operating system 402 suitable for controlling access to at least one storage device such as described in regards to FIG. 3, via a device driver 406. The storage controller 400 further is suitable for temporarily storing data in the cache 404, such as when destaging data.

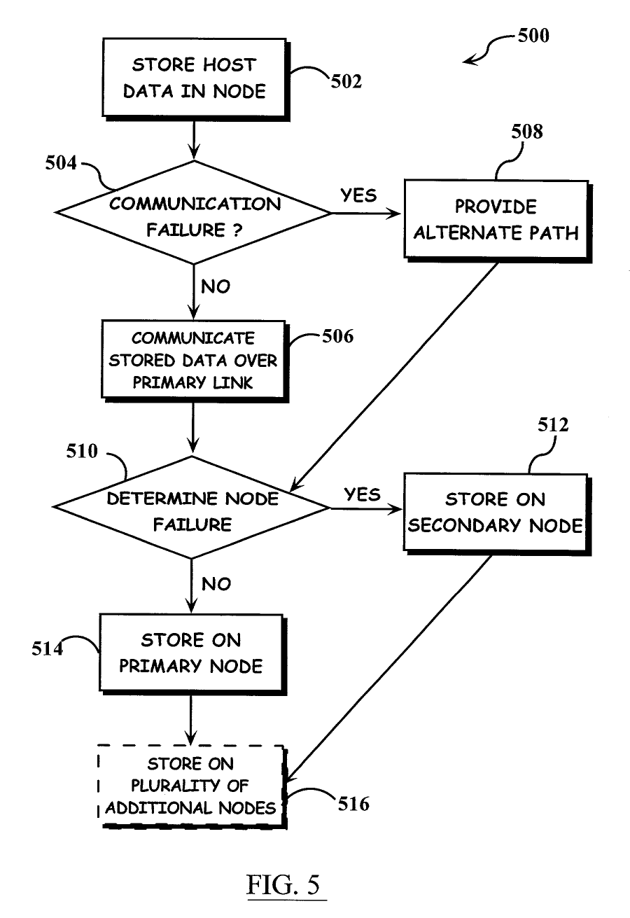

Referring now to FIG. 5, a method for providing redundant geographically disparate data storage of the present invention is shown 500. Data is initially stored on one node of the plurality of geographically disparate nodes 502. Stored data is communicated over at least one communication link to a primary redundant node 506. Communication between components, such as nodes may implement Fibre Channel, Gigabit Ethernet communication protocols and the like.

In event of a communication link failure 504 at least one alternate path is provided 508. Communication link failure may occur when the physical links are interrupted. In event the data cannot be communicated, an alternate path may include communicating data via an intermediate node and the like. The determination of communication link failure in further embodiments is achieved through utilization of latent messaging.

A determination as to the availability of the primary redundant node is made 510. If the node is available, such as the node being capable of accepting data, the data is communicated to the primary redundant node for storage 514. In the event of a node failure, such as if the storage devices are faulty, the node is non-responsive, data is communicated to at least one secondary redundant node 512.

The communicated data additionally may be sent to other nodes included in the storage system implementing the present method for data storage 516. The nodes storing the data may therefore provide a mirror copy in event of failure, thus permitting n-way recovery or rebuilding data should the node fail.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

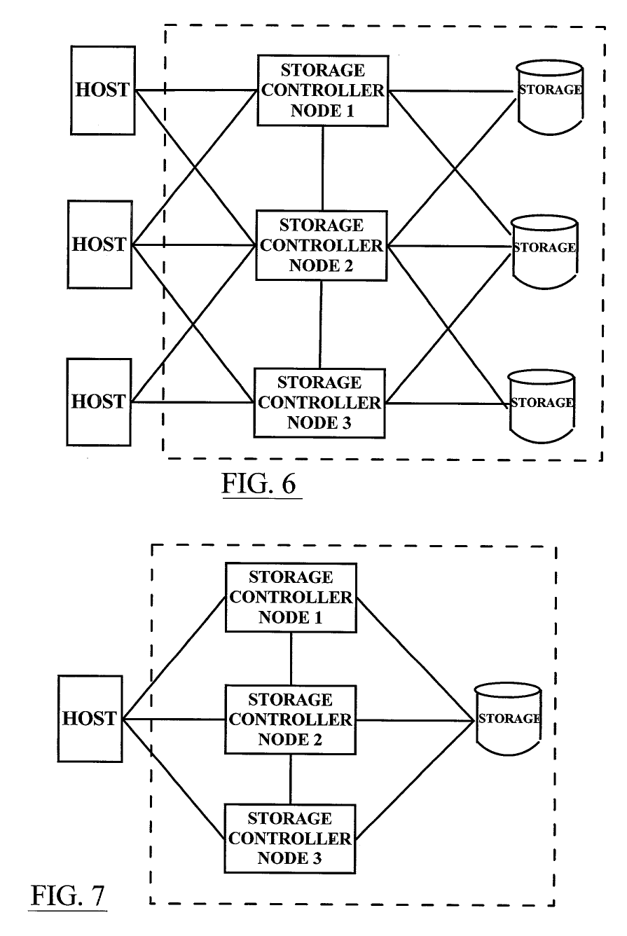

Referring generally to FIG. 6, an exemplary embodiment of the present invention is shown. In the present embodiment communication link and storage controller redundancy is shown wherein the at least one host device is capable of redundant communication with a plurality of node storage controllers. In the present embodiment the plurality of storage controllers may communicate with physical storage devices associated with the storage controller and physical storage devices at disparate locations.

Referring generally to FIG. 7, an exemplary embodiment of the present invention is shown. In the present embodiment communication link and storage controller redundancy is shown wherein multiple storage controllers disparately located may be accessed by at least one host. In the present example a storage controllers can access at least one storage device, thus the system is capable of providing redundancy for storage controllers.

Although the invention has been described with a certain degree of particularity, it should be recognized that elements thereof may be altered by persons skilled in the art without departing from the spirit and scope of the invention. One of the embodiments of the invention can be implemented as sets of instructions resident in the memory of one or more information handling systems, which may include memory for storing a program of instructions and a processor for performing the program of instruction, wherein the program of instructions configures the processor and information handling system. Until required by the information handling system, the set of instructions may be stored in another readable memory device, for example in a hard disk drive or in a removable medium such as an optical disc.

It is believed that the system and method for providing redundant data storage of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A system for redundant geographically disparate data storage, comprising:
a plurality of nodes for storing data, an individual node of the plurality of nodes is capable of redundantly backing-up at least one geographically disparate node of the plurality of nodes;
at least two communication links connecting the individual node of the plurality of nodes to at least two geographically disparate nodes of the plurality of nodes; and
at least one host device suitable for interfacing with stored data, communicatively coupled to the individual node of the plurality of nodes;
wherein the at least two communication links includes an alternate communication path between the individual node and the at least two geographically disparate nodes in the event of communication link failure.

2. The system for redundant geographically disparate data storage of claim 1, wherein an individual node of the plurality of nodes includes:
at least one data storage device;
a storage controller capable of controlling the plurality of data storage devices.

3. The system for redundant geographically disparate data storage of claim 1, wherein the at least two communication links utilize multiple communication protocols.

4. The system for redundant geographically disparate data storage of claim 3, wherein communication protocols are at least one of Gigabit Ethernet, Fibre Channel and asynchronous transfer mode.

5. The system for redundant geographically disparate data storage of claim 1, wherein any one node of the plurality of nodes is capable of providing redundancy for any other node of the plurality of nodes.

6. The system for redundant geographically disparate data storage of claim 1, wherein communication over the at least two communication links utilizes control information.

7. The system for redundant geographically disparate data storage of claim 1, wherein communication utilizes latent messaging for insuring communication link integrity.

8. The system for redundant geographically disparate data storage of claim 1, wherein the system implements error detection and correction to stored data.

9. The system for redundant geographically disparate data storage of claim 1, wherein the plurality of nodes are transparent to the at least one host device.

10. A system for redundant geographically disparate data storage, comprising:
a plurality of data storage nodes capable of redundant back-up of at least one other geographically disparate node of the plurality of nodes;
at least two communication links connecting at least one node of the plurality of nodes to at least two nodes of the plurality of nodes; and
at least one host device communicatively coupled to at least one of the plurality of nodes;
wherein an individual host device of the at least one host device is capable of accessing each node of the plurality of nodes.

11. The system for redundant geographically disparate data storage of claim 10, wherein the at least two communication links are suitable for providing alternate communication path in event of failure.

12. The system for redundant geographically disparate data storage of claim 10, wherein the at least two communication links utilize multiple communication protocols.

13. The system for redundant geographically disparate data storage of claim 12, wherein communication protocols are at least one of Gigabit Ethernet, Fibre Channel and asynchronous transfer mode.

14. The system for redundant geographically disparate data storage of claim 10, wherein any one node of the plurality of nodes is capable of providing redundancy for any other node of the plurality of nodes.

15. The system for redundant geographically disparate data storage of claim 10, wherein communication over the at least two communication links includes control information.

16. The system for redundant geographically disparate data storage of claim 10, wherein communication utilizes latent messaging for insuring communication link integrity.

17. The system for redundant geographically disparate data storage of claim 10, wherein the plurality of data storage nodes are transparent to the at least one host device.

18. A method for providing redundant geographically disparate data storage comprising:
storing data on one node of a plurality of geographically disparate nodes;
communicating the stored data over at least one communication link to a primary redundant node of the plurality of nodes;
in the event of a communication link failure, providing at least one alternate physical communication path for propagated data;
determining the availability of the at least one redundant node; and
in the event of redundant node failure, communicating stored host data to at least one secondary redundant node of the plurality of nodes;
wherein stored host data is stored on at least one of the redundant node and the secondary redundant node.

19. The method for providing redundant geographically disparate data storage of claim 18, further comprising the step of packaging host data with one of control data and content data prior to communicating the stored host data.

20. The method for providing redundant geographically disparate data storage of claim 18, wherein communicating stored data includes utilizing at least two different communication protocols.

21. The method for providing redundant geographically disparate data storage of claim 18, further comprising the step of rebuilding a failed node from one of the primary redundant node and the at least one secondary redundant node of the plurality of nodes in the event of node failure.

22. A system for redundant geographically disparate data storage, comprising:
a plurality of means for storing data, a data storage means of the plurality of data storage means is capable of redundant back-up of at least one other geographically disparate data storage means;
at least two means for communicating data connecting at least one data storage means to at least two data storage means of the plurality of data storage means; and
at least one means for interfacing with stored data, communicatively coupled to at least one of the plurality of data storage means;
wherein the at least two communication means includes an alternate communication path between data storage means in the event of communication means failure.

23. The system for redundant geographically disparate data storage of claim 22, wherein a data storage means of the plurality of data storage means includes:
at least one data storage device;
a controller capable of controlling the plurality of data storage devices.

24. The system for redundant geographically disparate data storage of claim 22, wherein the at least two communication means utilize multiple communication protocols.

25. The system for redundant geographically disparate data storage of claim 24, wherein communication protocols are at least one of Gigabit Ethernet and Fibre Channel.

26. The system for redundant geographically disparate data storage of claim 22, wherein communication over the at least two communication means utilizes content information.

27. The system for redundant geographically disparate data storage of claim 22, wherein any one data storage means of the plurality of data storage means is capable of providing redundancy for any other data storage means of the plurality of data storage means.

28. The system for redundant geographically disparate data storage of claim 22, wherein communication over the at least two communication means utilizes control information.

29. The system for redundant geographically disparate data storage of claim 22, wherein communication means utilize latent messaging for insuring communication link integrity.

30. The system for redundant geographically disparate data storage of claim 22, wherein the system for redundant geographically disparate data storage implements error detection and correction to communicated data.
